(19) United States
(12) Patent Application Publication
(10) Pub. No.: US 2015/0302201 A1
(43) Pub. Date: Oct. 22, 2015

(54) DEVICE AND METHOD FOR PROCESSING TRANSACTION REQUEST IN PROCESSING ENVIRONMENT OF TRUST ZONE

(71) Applicant: SAMSUNG ELEC TRONICS CO., LTD., Suwon-si (KR)

(72) Inventor: Jae-min RYU, Yeongwol-gun (KR)

(73) Assignee: SAMSUNG ELECTRONICS CO., LTD., Suwon-si (KR)

(21) Appl. No.: 14/421,620

(22) PCT Filed: Aug. 16, 2013
(86) PCT No.: PCT/KR2013/007387

§ 371 Date: Feb. 13, 2015

(30) Foreign Application Priority Data
Aug. 16, 2012 (KR) 10-2012-0089665

(51) Int. Cl. G06F 21/57

(52) U.S. Cl. CPC G06F 21/57; G06F 2221/034

(57) ABSTRACT

Provided is a device and method for operating a transaction application in a trust zone. The method includes confirming, by a processor, whether a transaction request from the application is performed in a processing environment of a secure world, and requesting an output unit, by the processor, for an output of notification information that corresponds to a result of the confirming, wherein the output of the notification information indicates that the transaction request is safe in response to the transaction request being performed in the processing environment of the secure world.

### BACKGROUND

1. Field

Apparatuses and methods consistent with exemplary embodiments relate to safely processing a transaction request from an application in a processing environment of a trust zone.

2. Description of the Related Art

With the development of communications and network technology, transaction techniques using a device have been commercialized. Also, installing a transaction application in a device and using a payment service through the installed transaction application by users have increased. However, there are various kinds of transaction applications, and the security of the transaction applications is controlled by software, thus the transaction applications have a problem of being vulnerable to hacking. In particular, if a transaction application is infected by a virus such as malware, an execution screen of the transaction application can be forged, and through the forged screen, transaction information stored in a subscriber identification module (SIM) card of a device is put in danger of exposure. Thus, it is required to develop a technique to strengthen the security of a transaction application and to effectively notify whether the transaction application safely operates.

### BRIEF DESCRIPTION OF THE DRAWINGS

The above and/or other aspect will be more apparent by describing certain exemplary embodiments, with reference to the attached drawings, in which:

FIG. 1 is a block diagram of a device according to an exemplary embodiment;

FIG. 2 is a block diagram illustrating a method of a device for processing a transaction request by an application, according to an exemplary embodiment;

FIG. 3 is flowchart illustrating a method of a device for outputting notification information according to a transaction request, according to an exemplary embodiment;

FIG. 4 is a flowchart illustrating a method of a device for obtaining transaction information from a subscriber identification module (SIM) card according to a transaction request, according to an exemplary embodiment;

FIG. 5 is block diagram illustrating a method of a device for storing a security key provided by an application in a SIM card, according to an exemplary embodiment; and

FIGS. 6 and 7 illustrate an example where a device outputs notification information, according to an exemplary embodiment.

### SUMMARY

According to an aspect of an exemplary embodiment, there is provided a method for operating a transaction application in a trust zone, the method including confirming, by the processor, whether a transaction request from the application is performed in the processing environment of the secure world, and requesting an output unit, by the processor, for an output of notification information that corresponds to a result of the confirming, wherein the output of the notification information indicates that the transaction request is safe in response to the transaction request being performed in the processing environment of the secure world.

Confirming and requesting may be performed by the processor corresponding to the processing environment of a secure world.

A first processor corresponding to the processing environment of the secure world and a second processor corresponding to the processing environment of the normal world are included in one processor and may be logically distinguished from each other.

The method may further include obtaining security information from a subscriber identification module (SIM) card that is controlled in the processing environment of the secure world in response to the transaction request being performed in the processing environment of the secure world.

Also, the method includes receiving a security key from the application, and providing the received security key to a SIM card controlled in the processing environment of a secure world, wherein the security key received may be provided to the SIM card in response to the application being authenticated in the processing environment of the secure world.

The output unit may be a light-emitting diode (LED) lamp, and the method may further include lighting the LED lamp in response to the request for the output of the notification information.

The output unit may be a display, and the method may further include displaying the notification information on the display in response to the request for the output of the notification information.

The method may further include operating the transaction application selectively in the processing environment of the secure world or a processing environment of a normal world.

According to another aspect of an exemplary embodiment, there is provided a device for operating a transaction application in a trust zone, the device including a processor configured to confirm whether a transaction request from the application is performed in a processing environment of a secure world, and request for an output of notification information that corresponds to a result of the confirmation; and an output unit configured to output the notification information that indicates the transaction request is safe in response to the transaction request is performed in the processing environment of the secure world.

The processor includes a first processor corresponding to the processing environment of a secure world and a second processor corresponding to a processing environment of a normal world, and the first processor may provide the output of the notification information to the output unit.

The first processor and the second processor are included in one processor and may be logically distinguished from each other.

Operations of the application may be divided into an operation performed in the processing environment of a secure world and an operation performed in the processing environment of a normal world.

The device may further include a subscriber identification module (SIM) card controlled in the processing environment of the secure world, wherein the processor is further configured to obtain security information from the SIM card in response to the transaction request being performed in the processing environment of the secure world.

The processor is further configured to receive a security key from the application, and the received security key may be provided to a SIM card controlled in the processing environment of a secure world in response to the application being authenticated in the processing environment of the secure world.

The output unit may include at least one of LED and a screen included in the device.

According to another aspect of an exemplary embodiment, there is provided a non-transitory computer readable storage medium that is executable by a computer to perform the method.

According to another aspect of an exemplary embodiment, there is provided a method of a processor operating a transaction application including: generating a transaction request from the application; determining whether the transaction request is performed in the processing environment of the secure world; and obtaining security information, from a subscriber identification module (SIM) card in response to the transaction request being performed in the processing environment of the secure world.

The method may further include obtaining a security key from the application; authenticating the transaction application in the processing environment of the secure world; and storing the security key in the SIM card in response the transaction application being authenticated.

### DETAILED DESCRIPTION

Exemplary embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the exemplary embodiments. However, it is apparent that the exemplary embodiments can be practiced without those specifically defined matters. Also, well-known functions or constructions are not described in detail since they would obscure the description with unnecessary detail.

Throughout the specification, it will be understood that when an element is referred to as being “connected” to another element, it may be “directly connected” to the other element or “electrically connected” to the other element with intervening elements therebetween. It will be further understood that when a part “includes” or “comprises” an element, unless otherwise defined, the part may further include other elements, not excluding the other elements.

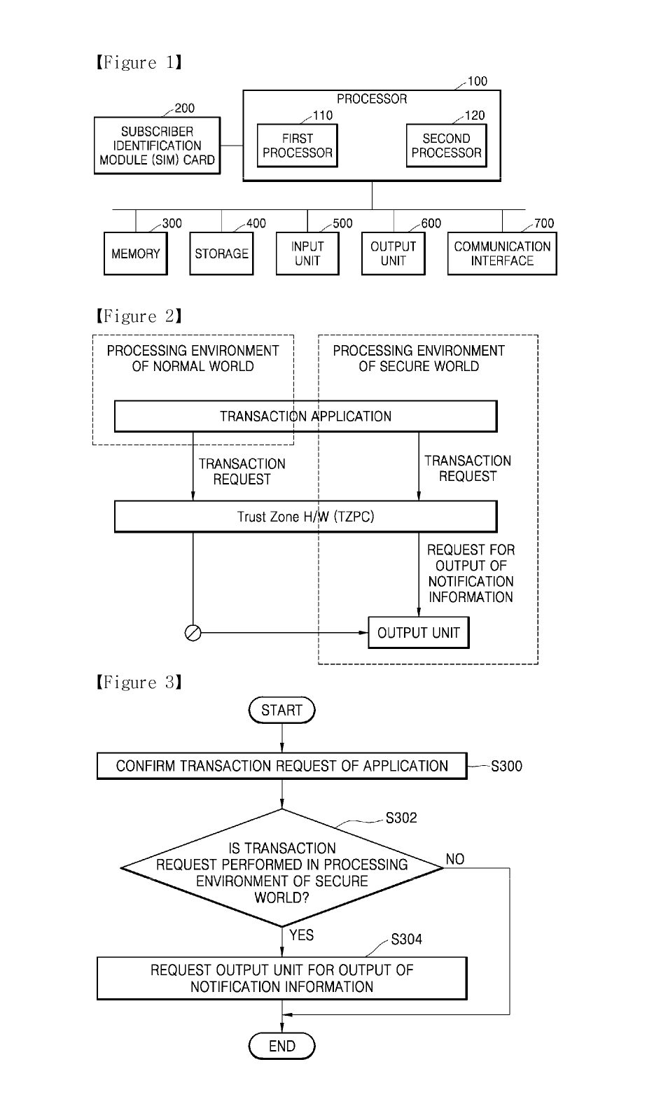

FIG. 1 is a block diagram of a device according to an exemplary embodiment.

As shown in FIG. 1, the device includes a processor 100, a subscriber identification module (SIM) card 200, a memory 300, a storage 400, an input unit 500, an output unit 600, and a communication interface 700. Also, the processor 100 may include a first processor of a secure world 110 and a second processor of a normal world 120.

In addition, the device operates in a processing environment of a “trust zone,” and may protect a processor circuit and memory of the device from a software attack. The processing environment of the “trust zone” may include a processing environment of a secure world and a processing environment of a normal world. Also, the processing environment of the normal world may not have an access to the processing environment of the secure world. Furthermore, a predetermined access to a hardware device may be set to be available only in the processing environment of the secure world.

The device may be a computing platform performing an application program. For example, the device may be a smart phone, a cellular phone, a personal digital assistant (PDA), a laptop, a media player, a global positioning system (GPS), or other mobile or non-mobile computing devices, but may not be restricted thereto. Also, the processor 100, the SIM card 200, the memory 300, the storage 400, the input unit 500, the output unit 600, and the communication interface 700 may respectively be connected to one another via a system bus including more than one bus. When there are a plurality of buses, buses may be bridged by more than one bridge of bus (not shown).

The processor 100 may be a central processing unit (CPU) having an architecture based on a secure structure type of a “trust zone.” The processing environment of the “trust zone” may protect a processor circuit and memory from a software attack. The processing environment of the “trust zone” may display data and security code, and may divide secure data and normal data to be separately processed with the help of hardware. The processor 100 may include the first processor of the secure world 110 and the second processor of the normal world 120. The first processor of the secure world 110 may perform a secure operation, and the second processor of the normal world 120 may perform a normal operation. Also, the first processor 110 may be separated from an access from the outside and be protected from an unauthorized control of the second processor 120. In addition, the first processor 110 and the second processor 120 may be physically separate processors, but may not be restricted thereto. The first processor 110 and the second processor 120 are included in one processor and may be distinguished logically.

Furthermore, an operation of an application according to an exemplary embodiment may be divided into an operation in a processing environment of a secure world and an operation in a processing environment of a normal world. For example, an operation related to transaction among operations of the application may be configured to be performed in a processing environment of a secure world, and an operation less related to a security such as a control of a user interface (UI) may be configured to be performed in a processing environment of a normal world. In this case, based on an input through the UI in the processing environment of the normal world, a transaction operation may be requested to the processing environment of the secure world.

The processor 100 confirms whether a transaction request is performed in a processing environment of a secure world. The processor 100 confirms whether the transaction request is performed by the first processor 110 or the second processor 120.

Also, whether the transaction request is performed in the processing environment of the secure world may be confirmed in the processing environment of the secure world. For example, the first processor 110 included in the processor 100 may confirm whether the transaction request is performed in the processing environment of the secure world.

Upon confirming that the transaction request is performed in the processing environment of the secure world, the processor 100 may request the output unit 600 for an output of notification information about safety of the transaction request. For example, when the application is hacked into and the transaction request is performed by the hacked application in a processing environment of a normal world, the processor 100 may confirm that the transaction request is not performed in the processing environment of the secure world and ignore the transaction request.

Upon confirming that the transaction request is performed in the processing environment of the secure world, the processor 100 may extract transaction information from the subscriber identification module (SIM) card 200. The transaction information, for example, may include a device user's user information, card information, and authentication information. Also, the SIM card 200 may be controlled in the processing environment of the secure world.

In addition, the processor 100 may receive a security key from the application and store the received security key in the SIM card 200. In this case, the processor 100 may authenticate the application, and when the application is authenticated, the processor 100 may store the received security key in the SIM card 200. Also, the authentication of the application may be performed in the processing environment of the secure world. For example, the application may be authenticated by the first processor 110 corresponding to the processing environment of the secure world.

The SIM card 200 stores transaction information and stores the security key received from the application. The SIM card 200 may be controlled by the processor 100 in the processing environment of the secure world. Also, the SIM card 200 may be connected to the first processor 110 corresponding to the processing environment of the secure world, but may not be restricted thereto.

The memory 300 may store an instruction and data used for performing an operation and function of the processor 100. The memory 300, for example, may include a random access memory (RAM), a static random access memory (SRAM), a dynamic random access memory (DRAM), a synchronous dynamic random access memory (SDRAM), and a double data rate random access memory (DDRRAM), but may not be restricted thereto. The memory 300 may include more than one code and/or data sequence and be referred to as an operating memory. The code sequence may be a machine instruction set or a machine instruction group indicating more than one function call, subroutine, or operation. In this specification, a program may individually refer to one among these, or a combination of more than one of these.

The storage 400 may indicate a non-volatile storage storing permanent data. A non-volatile storage denotes a storing medium maintaining the value even if the power of the storage device is removed. The permanent data denotes data that is maintained even if the power provided to the device is stopped. For example, the permanent data may include a system file, an operating system, a program file, and a configuration file. Also, the storage 400 may include a disk and a related drive (for example, a magneto-optical drive), a universal serial bus (USB) and a related port, a flash memory, a read-only memory (ROM), and a non-volatile solid state drive.

The input unit 500 generates an input signal input into the processor 100 based on an input by a user. The input unit 500, for example, may include a keyboard, a mouse, a touch screen, and a keypad, but may not be restricted thereto.

The output unit 600 outputs an output signal generated from the processor 100. The output unit 600 may output at least one of an audio signal and a video signal, but may not be restricted thereto. The output unit 600, for example, may include a display unit, a speaker, a vibration sensor, and a light-emitting diode (LED) lamp.

When a transaction request is performed in the processing environment of the secure world, the output unit 600 may output notification information about safety of the transaction request. For example, the output unit 600 may be an LED lamp, and the notification information about the safety of the transaction request may be output by the LED lamp flickering in certain colors and texture patterns. Also, the output unit 600 may be a display unit, and the notification information about the safety of the transaction request may be output by certain texts displayed on the display unit.

In addition, the output unit 600 may be set to be controlled only in the processing environment of the secure world.

The communication interface 700 enables the device to communicate with other devices through a network. The communication interface 700, for example, may include a network interface card, and a modem, but may not be restricted thereto.

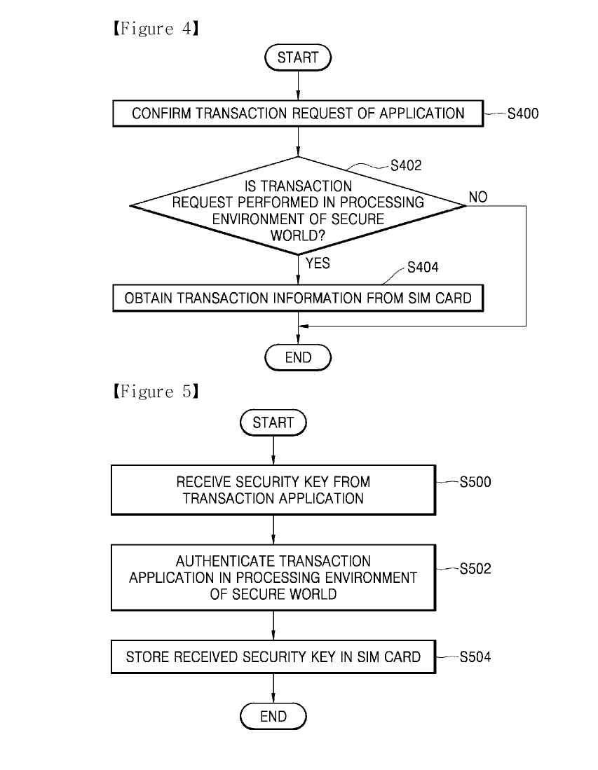

FIG. 2 is a block diagram illustrating a method of a device for processing a transaction request by an application, according to an exemplary embodiment.

As shown in FIG. 2, an operation of a transaction application may be performed in at least one of a processing environment of a secure world and a processing environment of a normal world. Also, an operation performed in the processing environment of the secure world and an operation performed in the processing environment of the normal world may be pre-set. For example, the transaction request may be set to be performed by the transaction application in the processing environment of the secure world.

If the transaction application operates normally and the transaction request is performed in the processing environment of the secure world, a trust zone protection controller (TZPC) may request the output unit 600 for an output of notification information about safety of the transaction request.

If the transaction application is hacked into and the transaction request is performed by the transaction application in the processing environment of the normal world, the TZPC may ignore the transaction request from the transaction application. However, it may not be restricted thereto, and the TZPC may request the output unit 600 for an output of notification information about unsafety of the transaction request.

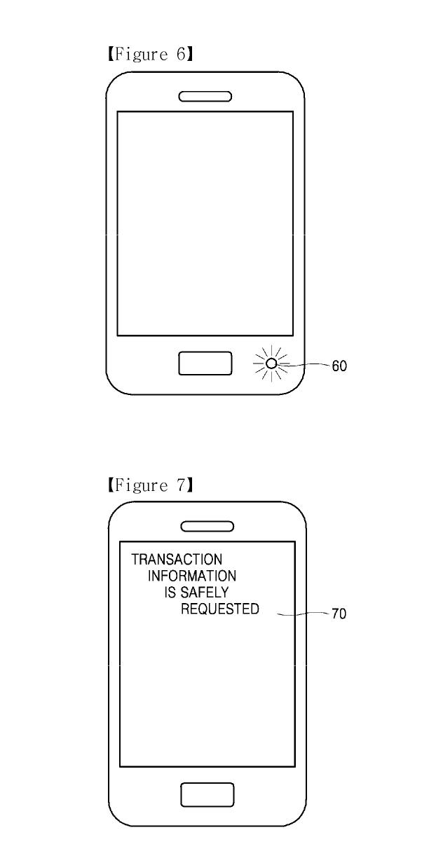

FIG. 3 is a flowchart illustrating a method of a device for outputting notification information based on a transaction request, according to an exemplary embodiment.

In operation S300, the device confirms a transaction request of an application. The application installed in the device may generate a request signal to obtain transaction information from the SIM card 200 so that the application is able to perform a transaction based on the transaction information. The device may confirm the transaction request performed by the application.

In operation S302, the device determines whether the transaction request is performed in a processing environment of a secure world. The device may determine whether the transaction request by the application is performed in the processing environment of the secure world, or a processing environment of a normal world. For example, the device may determine whether the transaction request is to be performed by the first processor 110 of the device or by the second processor 120 of the device, but may be not restricted thereto.

If the application is hacked into and the transaction request is performed by the application, the device may determine that the transaction request is to be performed in the processing environment of the normal world.

In operation S302, if it is determined that the transaction request is performed in the processing environment of the secure world, the device requests the output unit 600 for an output of notification information in operation S304. The notification information may include information about safety of the transaction request, and pre-set notification information according to the kinds of the output unit 600 may be output. For example, if the output unit 600 is an LED lamp, the notification information may be provided by the LED lamp flickering in certain colors and texture patterns. Also, if the output unit 600 is a display, the notification information may be provided by certain texts displayed on the display unit.

In addition, in operation S302, if it is determined that the transaction request is not performed in the processing environment of the secure world, the device may ignore the transaction request.

Operations S300 to S304 may be performed in the processing environment of the secure world, but may not be restricted thereto. Operations S300 to S304 may be partially performed in the processing environment of the normal world. Through operations S300 to S304, security-sensitive operations of the transaction application (e.g., processing the transaction request) may be isolated from the rest operations of the transaction application.

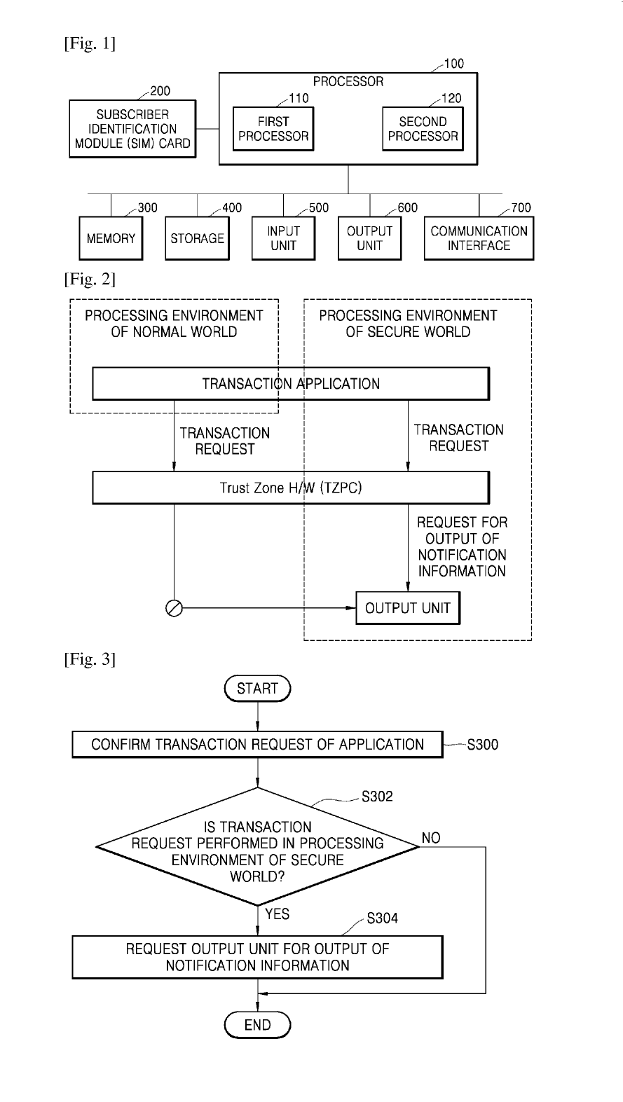

FIG. 4 is a flowchart illustrating a method of a device for obtaining transaction information from an SIM card based on a transaction request, according to an exemplary embodiment.

In operation S400, the device confirms a transaction request of an application. The application installed in the device may generate a request signal to obtain transaction information from the SIM card 200 so that the application is able to perform a transaction based on the transaction information. The device may confirm the transaction request by the application.

In operation S402, the device determines whether the transaction request is performed in a processing environment of a secure world. The device may determine whether the transaction request from the application is performed in the processing environment of the secure world or a processing environment of a normal world. For example, the device may determine whether the transaction request is performed by the first processor 110 of the device or by the second processor 120 of the device, but may not be restricted thereto.

If the application is hacked into and the transaction request is performed by the application, the device may determine that the transaction request is performed in the processing environment of the normal world.

In operation S402, if it is determined that the transaction request is performed in the processing environment of the secure world, the device extracts transaction information from the SIM card 200, in operation S404. For example, the transaction information may include a device user's user information, card information, and authentication information. Also, the SIM card 200 may be controlled in the processing environment of the secure world.

In addition, in operation S402, if it is determined that the transaction request is not performed in the processing environment of the secure world, the device may ignore the transaction request.

Operations S400 to S404 may be performed in the processing environment of the secure world, but may not be restricted thereto. Operations S400 to S404 may be partially performed in the processing environment of the normal world.

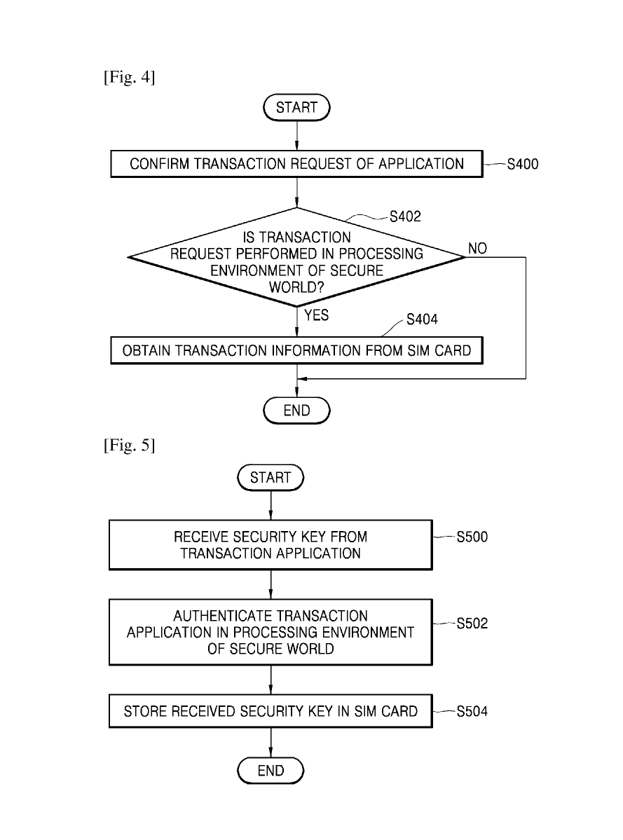

FIG. 5 is block diagram illustrating a method of a device for storing a security key provided by an SIM card, according to an exemplary embodiment.

In operation S500, the device receives the security key from a transaction application. The processor 100 of the device may receive the security key from the transaction application installed in the device. The security key may be generated by the transaction application or received from an external trusted party, but may not be restricted thereto.

In operation S502, the device authenticates the transaction application in a processing environment of a secure world. The first processor 110 corresponding to the processing environment of the secure world may confirm whether the transaction application is an authenticated application.

If the transaction application is an authenticated application, the device stores the security key in the SIM card 200, in operation S504. The SIM card 200 may be controlled by the processor 100 in the processing environment of the secure world. In this case, the security key may be stored in the SIM card 200 by using a near field communication (NFC) controller or a call processor operated in the processing environment of the secure world.

FIG. 5 illustrates an example where a security key of a transaction application is stored in a SIM card 200, but may not be restricted thereto. When a SIM client (not shown) operating in a processing environment of a normal world sends an application protocol data unit (APDU) command to an APDU agent (not shown) operating in a processing environment of a secure world, the APDU agent (not shown) may authenticate the SIM client (not shown). Also, if the SIM client (not shown) is authenticated, the APDU agent (not shown) may access the SIM card 200 by the NFC controller or the call processor operating in the processing environment of the secure world.

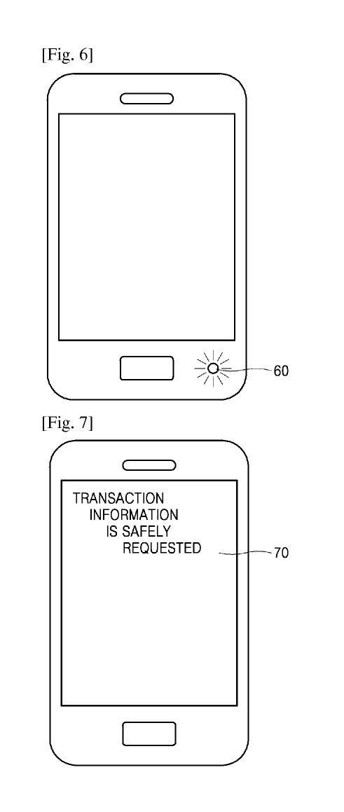

FIGS. 6 and 7 illustrate an example where a device outputs notification information according to an exemplary embodiment.

As shown in FIG. 6, when a transaction request is performed in a processing environment of a secure world, the device may notify about safety of the transaction request by lighting an LED lamp 60 in pre-determined colors and texture patterns.

Also, as shown in FIG. 7, when the transaction request is performed in the processing environment of the secure world, the device may display the text notifying about the safety of the transaction request on a screen of the device 70.

The exemplary embodiments may be embodied as a recording medium, e.g., a program module to be executed in computers, which include computer-readable commands. The computer storage medium may include any usable medium that may be accessed by computers, volatile and non-volatile media, and detachable and non-detachable media. Also, the computer storage medium may include a computer storage medium and a communication medium. The computer storage medium includes all of volatile and non-volatile media, and detachable and non-detachable media which are designed to store information including computer readable commands, data structures, program modules, or other data. The communication medium includes computer-readable commands, a data structure, a program module, and other transmission mechanisms, and includes other information transmission media.

The foregoing exemplary embodiments and advantages are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

1. A method for operating a transaction application in a trust zone, the method comprising:
confirming, by a processor, whether a transaction request from the application is performed in a processing environment of a secure world; and
requesting an output unit, by the processor, for an output of notification information that corresponds to a result of the confirming,
wherein the output of the notification information indicates that the transaction request is safe in response to the transaction request being performed in the processing environment of the secure world.

2. The method of claim 1, wherein the confirming and the requesting are performed by the processor corresponding to the processing environment of the secure world.

3. The method of claim 1, wherein a first processor corresponding to the processing environment of the secure world and a second processor corresponding to the processing environment of the normal world are included in the processor and logically distinguished from each other.

4. The method of claim 1, further comprising obtaining security information from a subscriber identification module (SIM) card that is controlled in the processing environment of the secure world in response to the transaction request being performed in the processing environment of the secure world.

5. The method of claim 1, further comprising:
receiving a security key from the application; and
providing the received security key to a SIM card controlled in the processing environment of the secure world,
wherein the received security key is provided to the SIM card in response to the application being authenticated in the processing environment of the secure world.

6. The method of claim 1, wherein the output unit is a light-emitting diode (LED) lamp, the method further comprising lighting the LED lamp in response to the request for the output of the notification information.

7. The method of claim 1, wherein the output unit is a display, the method further comprising displaying the notification information on the display in response to the request for the output of the notification information.

8. A device for operating a transaction application in a trust zone, the device comprising:
a processor configured to confirm whether a transaction request from the transaction application is performed in a processing environment of a secure world and request for an output of notification information that corresponds to a result of the confirmation; and
an output unit configured to output the notification information that indicates the transaction request is safe in response to the transaction request is performed in the processing environment of the secure world.

9. The device of claim 8, wherein the processor comprises a first processor corresponding to the processing environment of the secure world and a second processor corresponding to a processing environment of a normal world, and the first processor provides the output of the notification information to the output unit.

10. The device of claim 9, wherein the first processor and the second processor are included in one processor and are logically distinguished from each other.

11. The device of claim 8, wherein operations of the application are divided into an operation performed in the processing environment of the secure world and an operation performed in a processing environment of a normal world.

12. The device of claim 8, further comprising a subscriber identification module (SIM) card controlled in the processing environment of the secure world, and wherein the processor is further configured to obtain security information from the SIM card in response to the transaction request being performed in the processing environment of the secure world.

13. The device of claim 8, wherein the processor is further configured to receives a security key from the application, and the received security key being provided to a SIM card controlled in the processing environment of the secure world in response the application being authenticated in the processing environment of the secure world.

14. The device of claim 8, wherein the output unit comprises at least one of a light-emitting diode (LED) and a screen included in the device.

15. A non-transitory computer readable storage medium that is executable by a computer to perform the method of claim 1.

16. The method of claim 1, further comprising operating the transaction application, by the processor, selectively in the processing environment of the secure world or a processing environment of a normal world.

17. A method of a processor operating a transaction application, the method comprising:
generating a transaction request from the application;
determining whether the transaction request is performed in the processing environment of the secure world; and
obtaining security information, from a subscriber identification module (SIM) card in response to the transaction request being performed in the processing environment of the secure world.

18. The method of claim 17, further comprising:
obtaining a security key from the application;
authenticating the transaction application in the processing environment of the secure world; and
storing the security key in the SIM card in response the transaction application being authenticated.
